(19) United States
(12) Patent Application Publication
(10) Pub. No.: US 2008/0247400 A1
(43) Pub. Date: Oct. 9, 2008

(54) SYSTEM AND METHOD FOR INCREASING THE EFFICIENCY IN THE DELIVERY OF MEDIA WITHIN A NETWORK

(75) Inventor: Roland Schoettle, American Canyon, CA (US)

Correspondence Address: FULBRIGHT & JAWORSKI L.L.P, 2200 ROSS AVENUE, SUITE 2800, DALLAS, TX, 75201-2784, US

(73) Assignee: Optimal Licensing Corporation, Freeport GBI (BS)

(21) Appl. No.: 11/696,625

(22) Filed: Apr. 4, 2007

(51) Int. Cl. H04L 12/56

(52) U.S. Cl. 370/401

(57) ABSTRACT

The present invention is directed to providing a system and method for using pre-established sub-networks within a larger network to improve the efficiency of transmitting media. Specifically, the current invention eliminates the need to re transmit a particular medium from its source to a sub-network. In using pre-established sub-networks, the present invention avoids the capital outlay that would be necessary to set up an infrastructure for new sub-networks.

### CROSS-REFERENCE TO RELATED APPLICATIONS

The present application is related to co-pending, and commonly assigned U.S. patent application Ser. No. 11/683,304, Attorney Docket No. 66816/P012US/10609934, entitled “SYSTEMS AND METHODS FOR LINKING UTILITY CONTROL DEVICES;” U.S. patent application Ser. No. 11/683,327, Attorney Docket No. 66816/P013US/10609935, entitled “SYSTEM AND METHOD FOR INFRASTRUCTURE REPORTING;” U.S. patent application Ser. No. 11/683,298, Attorney Docket No. 66816/P014US/10614006, entitled “LIGHT SWITCH USED AS A COMMUNICATION DEVICE;” U.S. patent application Ser. No. 11/683,308, Attorney Docket No. 66816/P015US/10614005, entitled “SYSTEM AND METHOD FOR PREMISES MONITORING USING WEIGHT DETECTION;” U.S. patent application Ser. No. 11/683,326, Attorney Docket No. 66816/P016US/10614296, entitled “ANTICIPATORY UTILITY CONTROL DEVICE;” U.S. patent application Ser. No. 11/683,335, Attorney Docket No. 66816/P017US/10614295, entitled “PLUG AND PLAY UTILITY CONTROL MODULES;” and U.S. patent application Ser. No. 11/683,354, Attorney Docket No. 66816/P018US/10701603, entitled “SYSTEM AND METHOD FOR SUBSTITUTING DATA IN RESPONSES TO INTERNET INQUIRIES,” the disclosures of which are hereby incorporated herein by reference.

### TECHNICAL FIELD

This disclosure is directed to the delivery of media within a network in an efficient manner.

### BACKGROUND OF THE INVENTION

Traditional systems of distributing media such as movies, music, photographs etc. by mail or through retail stores are being supplemented and supplanted by distribution of these media via networks such as the Internet. Using the Internet for distribution eliminates mailing, transportation and retailing costs and in many respects is more efficient than traditional distribution systems.

Entities that distribute media via the Internet typically have web pages listing the various media available for download. Users access these web pages, make their selections, provide payment (usually by credit card) and then down load the selected media to their personal communication device. Depending on the location of the Media Company's server that stores the media and the location of the user, the media may have to be transmitted a long distance.

For example, if a company leasing movies via the Internet has its server in California, a movie requested by a user in New York, say movie Y, must be transmitted from California via the Internet to New York. While the transmission by Internet is more efficient than the traditional means of delivery, transmitting movie Y from California to New York each time a user in New York requests movie Y is not efficient. In other words, if one hundred New York neighbors of that first person to request movie Y subsequently request movie Y, then movie Y will be transmitted from California to New York another one hundred times consuming one hundred times more bandwidth over shared long distance network resources than if the media were redistributed locally in New York. Further, the company leasing movies must purchase sufficient bandwidth for each transmission and also verify that each movie is authorized for viewing by each user. These recurring bandwidth and authorization costs are a major component of ongoing overhead costs.

Consider the circumstance where many end-user satellite stations (e.g., personal computers, multi-media systems, television sets, audio players) all try to simultaneously download a large file from a central server, e.g. when a popular new movie, audio album, or software upgrade is released. Note: although these are different media types/files destined for different end-user satellite stations, they often share the same backbone network for media transport purposes (e.g., the Internet). This then tends to drive at least two critical phenomena: the primary data pipes become saturated; and, the server becomes overloaded. In either case, the media delivery data rate each end-user satellite station receives from the server tends towards zero. Further, when the server and/or network is overloaded, new end-user satellite stations are denied access to the server and/or experience complete media access failure because of packet losses and time-out failures. Therefore it is not uncommon for popular media downloads to take many (tens of) hours or longer. Obviously, delays of this magnitude do not allow for “on-demand” media delivery.

On its face, it would seem more efficient for Media Company to create satellite or re-transmission stations to serve local communities by delivering media to these satellite stations, then these satellite stations would in turn distribute the media to local communities. However, considering a media company that distributes movies, it would not be cost effective for such a media company to create satellite or re-transmission points, solely for distributing movies.

Unlike Peer to Peer (P2P) networking systems (e.g., BitTorrent), which is a method of distributing large amounts of data widely without the original distributor incurring the whole of the corresponding costs of hardware, hosting and bandwidth resources, this application focuses on the ability of gateway systems to establish their own gateway networks, where any gateway system can become a server to (numerous) other clients. For background, BitTorrent is a P2P network were instead of the Media Company or its distributor alone services each recipient (as with most online stores such as iTunes, Amazon, etc.), under BitTorrent the recipients each also supply data to newer recipients over pre-established ISP networks, thus significantly reducing the cost and burden on any given individual source as well as providing redundancy against system problems, and reducing dependence upon the original distributor. The challenge with BitTorrent-like systems is that although they send bits of data from numerous servers, they do not:

1) Send data chunks “in order” meaning that BitTorrent cannot be used to stream media data—the entire file must first be downloaded before it can be used. This is a very serious problem that significantly reduces the commercial appeal of BitTorrent-like offerings in our ‘on-demand’ world. In the current invention, because the data is controlled and therefore can be deconstructed into numbered and indexed pieces, the management of the indexed pieces could be replicated over gateway servers, where the requesting gateway could manage and control the reconstruction of the media file from more than one sending server in order to provide streaming media.

2) Intentionally try to minimize bandwidth requirements. In fact BitTorrent-like systems try to find the fastest servers (and many of them) without regard for bandwidth impacts and costs. The “neighbor” nodes are not chosen based on closest nodes but rather those nodes that are available no matter where they might be geographically. Although this is far more efficient because each node of potentially many can act as a server and therefore have potentially higher availability, if nodes are geographically distant (often the case) bandwidth requirements and costs can actually increase. The problem is that the increase is rarely the problem of the end-user, but rather the problem of the ISP or Media Company. For this reason, among others BitTorrent is used primarily for sending pirated files.

3) Provide for automatic creation of new “gateway networks”. What this means is that all other systems rely completely on the routing systems of the Internet and must run through ISPs. Although this application uses ISP networks as well, it does so to reduce network distances. But the real benefit here is that the gateway systems of this application (which are normally part of a predetermined regional ISP network and also normally part of a premise network) have extra communications capabilities that can be used to establish new, on-demand, gateway-to-gateway networks which can overlap many regional ISP networks. These overlapping newly created, on-demand, networks can therefore provide many new routes to other premise networks and to other regional networks which are on the Internet. Therefore, because of the underlying ability to control and distribute media through predetermined premise and regional (ISP) fixed networks AND the ability to create new “on-demand” gateway networks that overlap with the regional and premise networks it becomes reasonable to create and control a new “shortest path” link between the media and the requesting end-user devices.

4) Assign specific dedicated servers. In a BitTorrent community, all machines are peers with no one machine acting to control or authorize the media transaction. In one embodiment of this invention, all gateway machines that are to become temporary or permanent media servers are clearly assigned the task of serving media—there are normally no P2P functions that can cause last block deadlocks. Optionally, in another embodiment if there is any P2P function, it would only occur until and during the first iteration, when the gateway server is assembling the file for local distribution. Once the media file is complete on any gateway, that gateway can then become the server to other end-users deemed closest. Once the media file is on numerous close-by gateway servers a server and a route can be chosen to minimize gateway server load and network load (e.g., load balancing).

5) Use gateway systems. Gateway systems are defined herein as systems that are persistent, meaning they are always on and which normally link or control access to a premise network or satellite stations thereby allowing them to share information and comply with certain protocols. Gateway servers are gateway systems that add “store and forward” capabilities and that can optionally provide alternate network routes (pathways).

### BRIEF SUMMARY OF THE INVENTION

The present invention is directed to a system and method for using pre-established sub-networks within a larger network to improve the efficiency of transmitting media. Specifically, the current invention eliminates the need to repeatedly transmit a particular medium from its source to satellite stations.

Advantage is taken of the fact that media transmitted from a media company's central server through the Internet are transmitted to the user through an existing sub-network, typically via a gateway-type system such as a hub, router, switch, set-top-box, access point or media center. Those sub-networks can be used for providing particular services to a community of user devices within the same region. An example of such a sub-network is the local network of a home or building, sometimes referred to as a “premise network”. The premise network is typically part of a larger higher level regional network that encompasses numerous premise networks. As previously described, access from the regional network to the premise network is performed by a “gateway system”, typically consisting of any of gateway, router, hub, switch, access point, set-top-box, media center, etc. Where the gateway system can also act as a data repository and server, the gateway system is sometimes called a “gateway server.”

Numerous premise networks can be linked together under a larger higher level regional network most often organized under an Internet Service Provider (ISP) model where the provisioned data is supplied only through their regional servers. The typical ISP configuration is referred to as a “regional server to local client mode” network where the local client can be either a satellite station or a premise network gateway system. In contrast, when numerous gateway servers are optionally interconnected separately from their ISP(s) via separate network pathways into new “gateway networks”, the new network typically has the ability to assign any gateway server as a temporary persistent server to other interconnected satellite stations via their own (premise network) gateway servers. The new gateway networks are established so as to provide a high degree of overlap onto the largest number of pre-established regional networks, having the effect of providing the maximum number of alternate network pathways for media distribution.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a diagram illustrating one embodiment of the current invention;

FIG. 2 is a diagram illustrating one embodiment of the current invention;

FIG. 3 is a diagram illustrating one embodiment of the current invention; and

FIG. 4 is a flow diagram illustrating one embodiment of the operation of the current invention.

### GENERAL DISCUSSION OF ASPECTS OF THE INVENTIVE CONCEPT

The preferred embodiment is to allow each gateway system to communicate, via a separate communications channel, to other gateway servers within the region to establish the gateway network links described above. The separate communications channel can be either a hardware or software channel. For example, the gateway server can communicate within its own regional network to its designated ISP (e.g., via Cable or DSL modem) to use the Internet and/or it can use a separate communication channel (i.e. RF WiFi, Powerline Carrier) to establish the gateway network with the next gateway system. Note that a gateway server system or satellite station can be part of an ISP server-client mode regional network, a premise network, and a gateway network.

Note also that gateway networks can bridge across more than one regional network and therefore can provide alternate routes, via alternate ISPs, to the Internet and to the Media Company's Central Servers and Billing/Media Control Systems. Gateway systems and satellite stations that are part of any gateway network that traverses more than one regional network (and therefore provisioned by numerous ISPs) can provide numerous alternate routes onto the Internet and can provide for significant opportunities to select the fastest and shortest routes between servers. The overlapping “shortest route” nature of the regional and gateway networks that serve the premise network also allow for dramatic improvements in data delivery performance and costs. In the event the data (or any useful portion thereof) already is on one or more of the premise network gateway servers within the regional or gateway network, other satellite stations can request the data from any applicable premise gateway server(s) thereby eliminating the need to send media repeatedly over long distances.

Optionally, each time the satellite station requests new data from a gateway server other than its own, the closest gateway server with spare resources also stores the data for local retransmission, thereby eliminating the need to request the data from the same temporary primary gateway server and providing a useful form of load balancing. It should be noted that although an overlapping gateway network is preferred, the concepts described herein are also effective when using only numerous regional networks as these are typically much closer to each other and to the requesting satellite stations than the Media Company's Servers.

One embodiment of the present invention uses the gateway server in a premise network to store media downloaded from Media Company's central server. The premise gateways or servers then serve as a local distribution point, for Media Company's media, by downloading the stored media to satellite user devices being served by the gateway server in the regional network, gateway network, or premise network. In one embodiment, the regional network, gateway network, or premise network performs the distribution function while the main server performs the billing, authorization, rights management, control functions, and encryption. Optionally, each gateway server also performs billing, authorization, rights management, control and encryption functions.

This invention maximizes and balances the excess capacity of gateway systems for the purposes of reducing communications bandwidth requirements, reducing processing requirements, increasing network throughput, reducing network costs, increasing QoS, and improving the response times from Media Company servers to satellite stations using the following distinct (network and media server) methods:

1) The invention uses a system and method of using numerous normally available (persistent) gateway systems as gateway servers to propagate relevant media closest to satellite stations making media requests. The invention also uses the store and forward capabilities of gateway servers already established for another purpose and increases the efficiency of downloading media without installing new dedicated gateway servers for media distribution within local networks. It should be noted that while the resources, both bandwidth and processing, at the Media Company's servers can often be completely exhausted, the gateway servers to premise networks that in turn serve end-user satellite stations, usually have ample spare capacity.
a) This in effect creates/enables numerous gateway servers closest to the satellite stations without the requirement for satellite stations to become peer servers on the network (as with P2P networks). The benefit is that gateway servers are highly persistent whereas satellite stations are highly intermittent which means media server operations are highly reliable and repeatable (satellite stations that are servers, as with P2P methods, require reloading and republishing of media each time they enter the network, which significantly increases network load and costs).
b) This also significantly increases the likelihood of relevant media is closer and more responsive to satellite stations close-by. This in effect increases the efficiency of downloading media without installing new gateway servers for distribution of media within local networks.

2) The invention uses a system and method of using pre-established regional networks from which to communicate to the persistent gateway servers of item 1, above. It does this by using regional networks already established for another purpose (e.g., ISP sub-networks). This in effect uses numerous pre-established regional networks (pre-determined physical pathways) to link numerous gateway servers and provides for performance of shortest path routing, fastest path routing, media load balancing, gateway load balancing, network load balancing, and Quality of Service (QoS) routing and management (e.g., for VoIP jitter and video streaming) over numerous pre-established regional networks.

3) The invention uses a system and method of establishing new gateway networks that physically overlap the regional networks in 2, above. It does this by establishing (using another hardware/software network interface) alternate physical paths to other regional networks beyond the one originally pre-assigned to it. This in effect, creates numerous new physically overlapping gateway networks that provides for overlapping/redundant/shorter-path routes to the nearest/best gateway server that can provide relevant media. Further, these alternate and overlapping paths allow for significantly improved shortest path routing, fastest path routing, gateway load balancing, network load balancing, and Quality of Service (QoS) routing and management (e.g., for VoIP jitter and video streaming) over a manageable combination of regional and gateway networks.

4) The invention uses a system and method of using pre-established regional networks from which to logically/systemically communicate to the persistent gateway servers of item 1, above. It does this by using regional networks already established for another purpose (e.g., ISP sub-networks). This in effect, allows for best (automatic) determination of logical redundant routes using physically pre-established ISP sub-networks to the nearest/most-efficient gateway server that can provide relevant media. Further, these logical redundant routes allow for significantly improved shortest path routing, fastest path routing, gateway load balancing, network load balancing, and Quality of Service (QoS) routing and management (e.g., for VoIP jitter and video streaming) over numerous physically pre-established regional networks.

5) The invention uses a system and method of establishing new gateway networks that logically/systemically overlap the regional networks in 2, above. It does this by establishing (using another network interface) alternate logical paths to other regional networks beyond the one that originally assigned to it. This in effect, allows for best (automatic) determination of logical overlapping/redundant routes using new physical gateway networks to the nearest gateway server that can provide relevant media. Further, these alternate and overlapping paths allow for significantly improved shortest path routing, fastest path routing, gateway load balancing, network load balancing, and Quality of Service (QoS) routing and management (e.g., for VoIP jitter and video streaming) over a manageable combination of regional and gateway networks.

6) The invention uses a system and method of requesting and pulling media data from any gateway server regardless of whether pre-established regional, newly established gateway, or any combination of these networks is used.

7) This invention determines, uses and balances redundant/overlapping network pathways to increase the number of network routes to the nearest gateway server that contains media relevant to the requesting satellite station and to reduce network overhead (determines the best routes to minimize the bandwidth requirements and time the media file is traveling in the network).

8) The invention uses a system and method of propagating a ranked list of the highest demand media files to all gateway servers within a specific network region. Only the highest demand media files are propagated automatically throughout the region whereas low demand media files are registered on a smaller subset of gateway servers (registry gateway servers) with excess resources. When any gateway server requests a popular media file for download, it already knows where to get it (it has the list of popular files and the best network pathways from where to get it). For media files not on the popular list it goes to the nearest registry gateway server which maintains a complete list of both popular and less popular media files up to its maximum memory capacity. For media files deemed unpopular (not otherwise registered in gateway servers), the media files will be downloaded from the Media Company's servers. Since this approach does not require a central network manager to maintain the exact state of each gateway server, it has the ability to scale well (and within a very small time period).

9) The invention uses a system and method of requesting and pulling specific media data blocks from numerous gateway servers simultaneously, based on delivery performance, and reassembling these data blocks for the purpose of streaming media. In other words, unlike Peer-to-Peer protocols such as the popular BitTorrent, which must receive the entire media file before it can be used, this invention allows for streaming media which can be viewed as it streams in from the nearest gateway servers.

10) The invention does not require a centralized management system for network configuration and network performance maximization. (network function (logical))

11) The invention does not require a centralized media management system for media downloads. Each gateway server can tailor its download strategy to the amount of locally available bandwidth, processing capacity, memory, and media priority.

12) This invention uses and balances the excess capacity of gateway systems for the purposes of managing, disassembling into numerous fixed-size blocks, reassembling from numerous blocks, and streaming media files from the nearest gateway server. Successful downloads consist of reassembling these blocks in a data stream that allows partial (and completed) media files to operate at the requesting satellite station. The set of gateway servers that have already downloaded any particular media files form a non-random, organized “per media community” for that particular media and have the ability redirect traffic to other less stressed gateway servers within the community. Update messages of which gateway servers have all blocks are propagated automatically through the community, thereby reducing the classic “last block” problem, where all gateway servers (or their satellite stations) in the system have all but one block, and they all try to get the last block from the Media Company Server, dramatically impacting performance. With the update knowledge, each satellite station can either download a given block from a gateway server, or from the Media Company server. Update information for each community includes closest neighbor, all neighbors, addresses, ports, authorization/block-lists, hopcounts, node-degrees, etc. These form the basic information units that alert other gateway systems of new gateway servers joining the system, and optionally, who has which blocks where the media in any gateway server is still incomplete.

13) This invention allows any gateway system to start and maintain its own media server and alternate network functions and to adapt and tailor its own gateway network to other gateway systems. The invention does not require a centralized management system to operate (although in some embodiments, it would be preferable to have centralized management as a parallel/backup/fallback system).

14) This invention allows any gateway server to perform cryptography, virus/spyware scanning, media integrity checking, media authorization/deauthorization, and digital rights management.

15) In this invention blocks served by gateway servers are downloaded before blocks served by the Media Company (source) servers. When multiple gateway servers have the same block, the closest (shortest pathway) gateway server that still meets minimum performance specifications is chosen. Minimum performance specifications include: gateway server and network pathway load (overload, underload, at load), jitter, latency, etc. Gateway systems that can act as gateway servers only connect to other gateway servers if they have excess capacity, if they do not have the latest local high volume media, and if a satellite station connected to it requests a media file that is otherwise not available within the region. In this way the load on the Media Company server can be reduced significantly independent of the number of gateway servers and independent of any centralized control system. More importantly, the network load, the associated cost of media delivery and the lag times for media delivery are dramatically reduced.

### DETAILED DESCRIPTION OF THE INVENTION

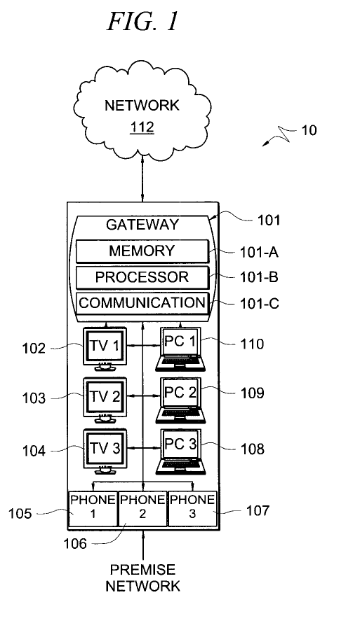

FIG. 1 is a diagram illustrating one embodiment of the current invention showing a gateway system within a premise network 10. Premise network 10 comprises a gateway 101. Gateway 101 includes memory 101-A, processor 101-B and communications 101-C. Gateway 101 links or controls access of satellite stations (user devices) 102-110 to a network 112.

In operation, for example, media down loaded to satellite station 102, from network 112, may be intercepted by gateway 101 and stored in memory 101-A, prior to download to 102. Subsequent to media being stored in memory 101-A, the media is also available to the other satellite stations in premise network 10, i.e. satellite stations 103-110, from memory 101-A. This avoids the need to download media, already stored in memory 101-A, from the more distant network 112. Thus, the need for media re transmission (and its attendant resources), from the network 112 to premise network 10, is avoided by storing the media in gateway 101 the first time the media enters the premise network 10.

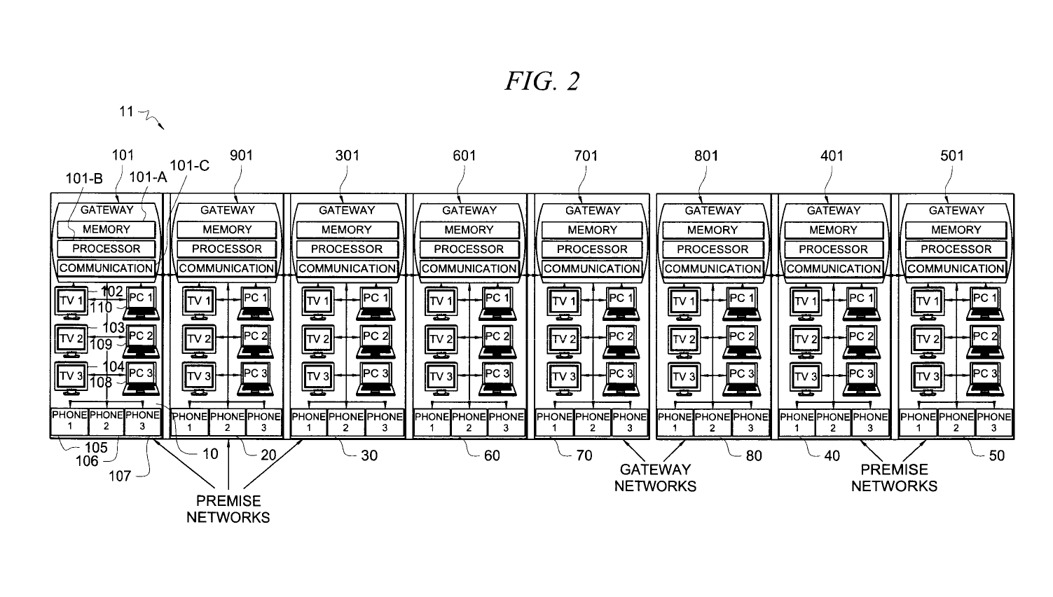

FIG. 2 is a diagram illustrating one embodiment of the current invention showing a gateway network system 11. Gateway network system 11 includes several premise networks 10, 20, 30, 40 and 50. Along with the premise networks, gateway system 11 may also include gateway networks 70 and 80. The premise networks are in communication with each other via gateways 101, 201, 301, 401 and 501. The gateway networks are in communication with each other via gateways 701 and 801. Gateways 701 and 801 are also in communication with premise network gateways 101, 201, 301, 401 and 501.

In operation, for example, media may be stored in memory 101-A as a result of the process described above with regard to a gateway system within a premise network. As discussed above, such media is available to satellite stations in premise network 10. Additionally, however, because premise network 10 is part of a gateway network, any media stored in 101-A is also available to all the satellite stations connected to gateway 101. Therefore, satellite stations in the other premise networks served by gateways 201, 301, 401 and 501 and satellite stations in gateway networks served by gateways 701 and 801 may receive media stored in memory 101-A. Consequently, the storage of media in gateway 101 eliminates the need for that media to be downloaded from more distant sources than gateway 101. Bandwidth costs and transmission costs are therefore saved if the media stored in gateway 101 is downloaded by any satellite station served by gateways in communication with gateway 101 (i.e. gateways 201, 301, 401, 501, 601, 701 and 801).

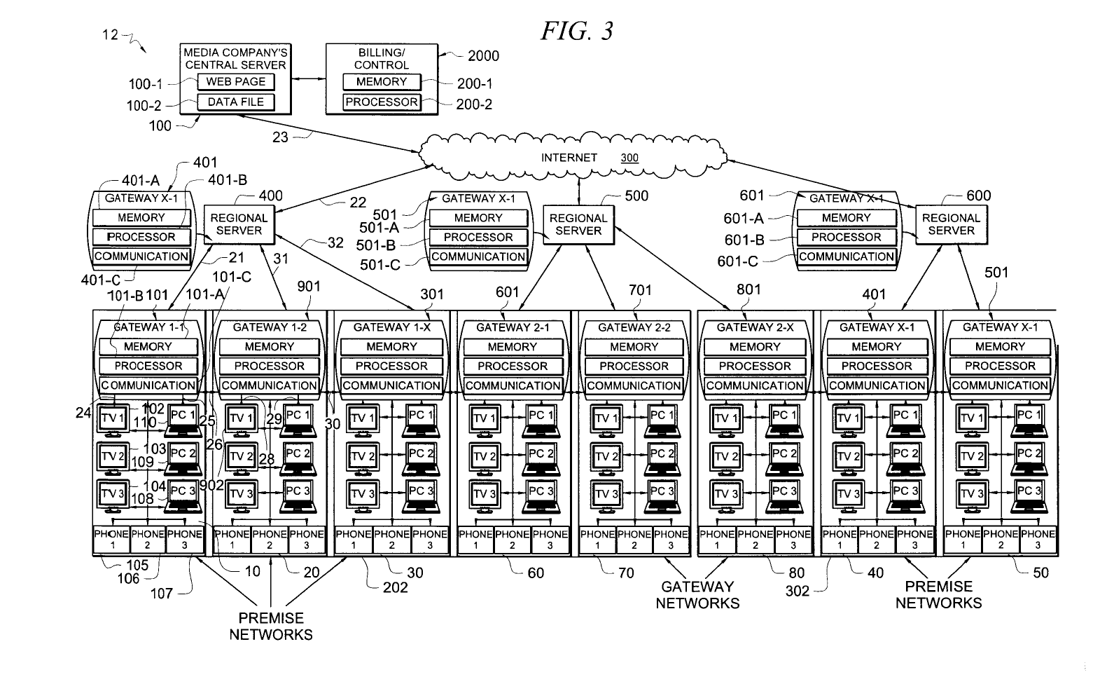

FIG. 3 is a block diagram illustrating one embodiment 12 of the current invention showing a gateway network system interfacing with regional networks and a media server. As shown in FIG. 3, central server 100 is the server on which a media company stores its media. The type of media contemplated in the current invention includes, but is not limited to, video, audio and photographs which, in the embodiment are delivered to a user as a data file, such as data file 100-2. A user at satellite station 102, within premise network 10, selects media from lists on Media Company's web page 100-1. The user accesses Web page 100-1 through Internet 300. Premise network 10 comprises a gateway 101, and satellite stations such as televisions and personal computers 102-110. Premise network 10 is connected to the Internet via a gateway system or regional server 400.

In one embodiment, the regional server is directly controlled by an entity. This entity may perform shortest path routing, fastest path routing, gateway load balancing, network load balancing, and Quality of Service (QoS) routing and management (e.g., for VoIP jitter and video streaming). It should also be noted that gateway systems include gateways, routers, hubs, switches, access points, set-top-boxes, media centers and other such devices that can store and forward media. It should also be noted that user devices include computers, mobile telephones, music/audio player/recorders, video player/recorders, personal data assistants, televisions, media centers, VCRs and such other devices that can receive and transmit media.

In operation, for example, satellite station 102 within premise network 10 selects movie Y from web page 100-1 and makes a request, with payment as processed via billing/media control 200, that movie Y be downloaded to satellite station 102. In such a situation, the user request would follow a prescribed path defined in this example via path 21, then through regional server 400 to the Internet along path 22 and from the Internet to Media Company's central server along path 23. Media Company's central server would then download the file containing movie Y along path 23 to the Internet, and then along path 25 to Regional server 102 and then along path 21 to premise network 10 and then path 24 to satellite station 102.

Using the example, and as discussed above, regarding the transmission of a movie from California to New York, paths 23, 22 and 21 would be relatively long because premise networks 10, 20 30, 40 and 50 are, for example, located in New York, while Media Company's server is located perhaps in California. The present invention provides alternative routes for downloading the movie to the satellite stations in New York that are shorter and use less bandwidth and other resources.

In operation, after Media Company's central server downloads movie Y to gateway 101 the first time, movie Y may be stored in memory 101-A. Thereafter, movie V is available for download to other satellite stations in premise network 10 such as satellite station 110. For example, if after satellite station 102 requests movie Y, the user at satellite station 110 requests movie Y, media server 100, under control of billing control 120 downloads movie Y to the user satellite station 110.

In some embodiments, if desired, gateway 101 would intercept the request for movie Y, download it to user device 110 and inform billing control 120 so that the user can be billed or otherwise accounted for. Consequently, this operation downloads movie Y along path 25 and thereby eliminating paths 23, 22 and 21. Transmission paths 23, 22 and 21 would also be eliminated when the system responds to any other subsequent requests for movie Y within premise network 10 from satellite stations 102 to 110. The route from gateway 101 to satellite station 110, as compared to Media Company's server 100 to satellite station 111, is shorter and requires less bandwidth.

Additionally, movie Y is available to other premise networks 10, 20, 30, 40 and 50 and gateway networks 70 and 80 that are in the gateway network system and as a result of the prior download of movie Y to satellite station 102. The gateways communicate with each other and each knows what media is stored on each other. For example, satellite station 202 (which is within premise network 20) may request movie Y from media server 100. In one embodiment, gateway 201 would intercept that request. Gateway 201 would have information that movie Y is stored in a location closer than media server 100, i.e. gateway 101. Therefore, gateway 101 would communicate with gateway 201 to effectuate the download of movie Y from gateway 101 to satellite station 102 along paths 26 and 28 instead of the longer distance of paths 23, 22, 31 and 28.

After being downloaded to the particular premise networks 10 and 20, movie Y may now be stored in gateways 101 and 102. Thus, if satellite station 802 in gateway network 80 requests movie Y from media server 100, movie Y may be downloaded from three possible sources, namely media server 100, gateway 101 or gate way 201. Thus, in one embodiment, the present invention provides that gateway 801 determines which of these three sources it would be best to download movie Y from and also the best route. This determination may depend on but not limited to factors such as media delivery speed; media fragmentation, media fragment locations, network speed; shortest distance; network QoS. In order to facilitate the determinations of best source and best routes, in one embodiment, each gateway within the network has the ability to publish, to each other gateway, parameters pertaining to the publishing gateway.

After making the determination of best source and best route, the media is downloaded from the determined best source and along the determined best route. Additionally, gateway 801 may determine it is best to download movie Y from all three sources. In such a case, gateway 801 is capable of downloading the media in numbered and indexed pieces. In one embodiment the requesting gateway manages and controls the reconstruction of the media file in order to provide streaming media.

It should be noted that while the example uses gateways within a gateway network system, any gateway within the electronic network may be used as a server for storing media. For example, regional server 400 connects several premise networks within a region, such as premise network 10, 20 and 30, to the Internet and thereby creating a regional network. When media is downloaded, for the first time, to any satellite station within these premise networks, regional server 400 could intercept the media prior to download to the premise networks and store the media in memory 401-A. Subsequently, the media would be available for download from memory 401-A to satellite stations within all premise networks served by regional server 400. Regional server 400 may also serve as a source of media to other regional networks via various routes. These routes include but are not limited to communications between regional servers (example between regional server 400 and regional server 500) or communication between regional servers and to a gateway in the source region and then to a gateway in the destination region (example from regional server 400 to gateway 301 and then to gateway 601). It should be noted that one example of a regional network is an ISP network.

A person skilled in the art should recognize that the number of possible media transmission routes, more efficient than the transmission route from the central server to the user device, is a function of the number of regional networks, gateway networks, premise networks and where the particular media is stored etc. Accordingly, one embodiment of this invention includes determining the most efficient route by an analysis of the permutations and combinations of the several elements that determines the possible routes.

In sum, the current invention increases the efficiency of downloading media without creating new satellite points for distribution within local networks. The current invention does this by using networks already established for other purposes. Additionally, where there are a plurality of sources from which to download a particular media, the current invention determines the best sources and best routes for delivery of the media.

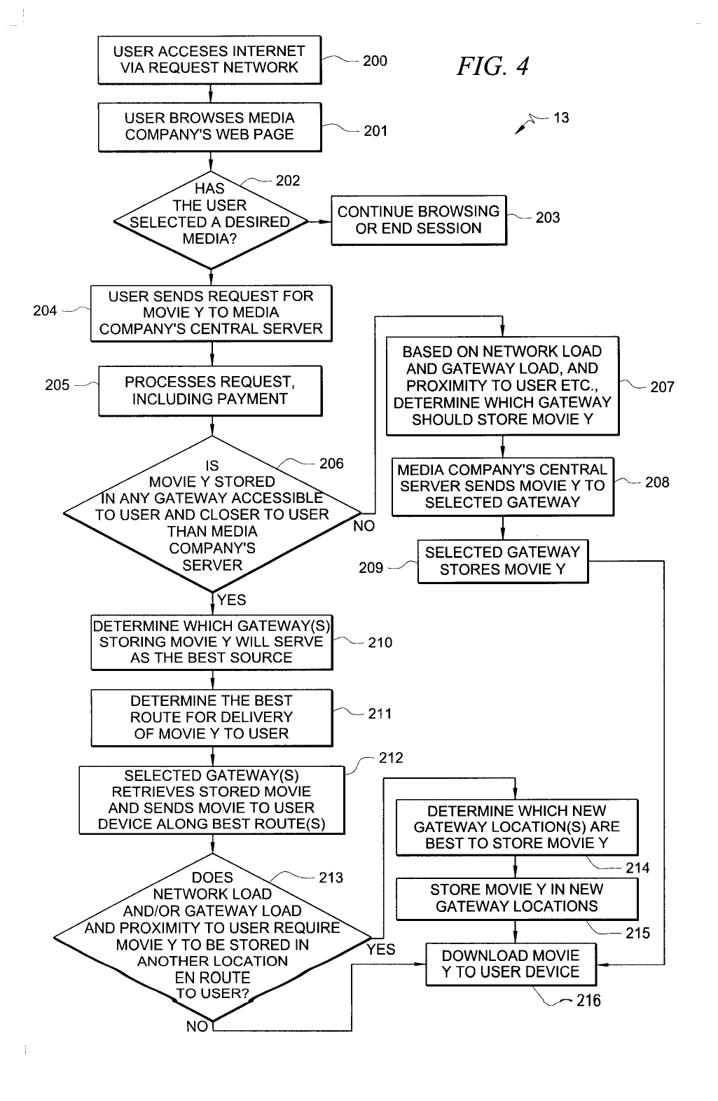

FIG. 4 is a flow diagram illustrating one embodiment 13 of the operation of the embodiment as shown in FIG. 3. The method commences at process 200 where the user accesses the Internet via a regional server. In process 201, the user browses Media Company's web page in order to select a desired media, such as movie Y. Process 202 determines if the user has selected a desired media. If not, process 203 allows the user to continue browsing or to end the session. If the user selects a media, such as movie Y, in step 204 the user sends a request for movie Y to Media Company's central server. The Media Company's central server 100 then processes the request and controls payment in process 205. Process 206 determines if movie Y is stored in a gateway accessible to the user and closer to the user than Media Company's server.

If movie Y is not stored on a gateway accessible to the user and closer to the user than Media Company's server, then based on proximity to user, network load and gateway load etc., the system determines which gateway(s) in the gateway system should store movie Y in process 207. In process 208, Media Company's server sends movie Y to the gateway(s) that selected in process 207. In step 209, the selected gateway(s) stores movie Y. Movie Y is then downloaded to the requesting satellite station in step 216. The gateway server then, if desired, sends information to Media Company's central server that movie Y has been transmitted.

If movie Y is stored in gateway(s) accessible to the user and closer to the user than Media Company's server, then process 210 determines which gateway(s) storing movie Y will serve as the best source(s) from which to download movie Y. In process 211 the best route(s) for delivering movie Y is determined. The selected gateway(s) then retrieves stored movie Y and sends movie Y to the requesting satellite station in process 212, using the best route(s). In process 213 the system determines whether proximity to user, network load and/or gateway load etc., requires movie Y to be stored in another location while en route to user.

If the parameters such as proximity to user, network load or gateway load etc. determines movie Y is to be stored in another location then, in process 214, the new location is determined. Then, in process 215, movie Y is stored in the new location(s) Movie Y is then downloaded to user device in process 216. If based on the network load, gateway load or proximity to user, it is determined that movie Y is not to be stored in another location, then movie Y is downloaded directly to user device in process 216. The gateway server, if desired, sends information to Media Company's central server that movie Y has been transmitted. It should be noted that the user device that transmits the request for movie Y need not be the user device to which movie Y is downloaded as would occur, for example, when a mobile user requests a media download to a home device.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A gateway system comprising:
at least one memory for storing therein media transmitted from at least one central media server located remote from said gateway system, said media server accessible to said gateway system via an electronic network;
at least one processor for interfacing a plurality of user devices to said electronic network; and
said at least one processor further operable for downloading a particular one of said stored media to at least one user interfaced thereto, said particular media being selected by said media server.

2. The gateway system of claim 1 wherein said gateway system is normally persistent.

3. The gateway system of claim 1 wherein said gateway system acts as a local media server.

4. The gateway system of claim 1 wherein said gateway system further comprises:
a plurality of gateway servers, and means for dynamically determining without centralized network management, the best gateway server and the best network path from which to obtain said media at any point in time.

5. The gateway system of claim 1 wherein said particular one of said stored media is stored as a result of downloading said media to one of said interfaced users as directed by said media server.

6. The gateway system of claim 1 wherein at least a portion of said stored media is stored as a result of downloading said media to one of said interfaced users as directed by said media server.

7. The gateway system of claim 1 wherein said memory is part of a gateway server processor, said processor further operable for sending and receiving reports to and from said media servers and to said gateway server pertaining to downloaded ones of said media.

8. The gateway system of claim 1 wherein said gateway system is part of a premise network.

9. The gateway system of claim 1 wherein said gateway system is a long-term media server.

10. The gateway system of claim 1 wherein said gateway system is part of a gateway network.

11. The gateway system of claim 1 wherein said gateway system is part of a regional network.

12. The gateway system of claim 1 wherein said gateway system is a temporary media server.

13. A gateway network system comprising:
a plurality of gateway systems interconnected to each other by a network and further connected to at least one central media server located remote from said plurality of gateway systems, wherein at least one of said plurality of gateway systems comprises:
memory for storing therein media transmitted from said at least one central media server;
a processor for interfacing a plurality of user devices to said electronic network;
said processor further operable for downloading a particular one of said stored media to at least one user interfaced thereto, said particular media being selected by said media server;
at least one network interface comprising:
at least one memory for storing therein media transmitted from at least one central media server located remote from said gateway, said media servers accessible to said gateway system via said network.

14. The gateway network system of claim 13 wherein said gateway network system is selected from at least two gateway systems.

15. The gateway network system of claim 13 wherein said gateway network system comprises at least one gateway server, said gateway server being normally persistent.

16. The gateway network system of claim 13 wherein said gateway network system is connected to a central media server.

17. The gateway network system of claim 16 wherein said connection to said gateway network system is intermittent.

18. The gateway network system of claim 13 wherein each of said gateway systems is connected to separate upstream regional networks via predetermined physical pathways.

19. The gateway network system of claim 13 wherein each of said gateway systems is connected to the same upstream regional networks via predetermined physical pathways.

20. The gateway network system of claim 13 wherein each of said gateway systems is connected to separate downstream premise networks via predetermined physical pathways.

21. The gateway network system of claim 13 wherein any of said gateway systems is connected to a predetermined upstream physical pathway and wherein said gateway system further comprises:
at least one permanent alternate connection to another gateway system otherwise connected to a different predetermined physical upstream pathway.

22. The gateway network system of claim 13 wherein any of said gateway systems is connected to a predetermined upstream physical pathway and wherein said gateway system further comprises:
at least one permanent alternate connection to another gateway system otherwise connected to the same predetermined upstream physical pathway.

23. The gateway network system of claim 13 wherein each of said gateway systems is connected to separate upstream regional networks via predetermined logical pathways.

24. The gateway network system of claim 13 wherein each of said gateway systems is connected to the same upstream regional networks via predetermined logical pathways.

25. The gateway network system of claim 13 wherein each of said gateway systems is connected to separate downstream premise networks via predetermined logical pathways.

26. The gateway network system of claim 13 further comprising:
means in said gateway systems for allowing said gateway systems to actively coordinate with other gateway systems to publish each of their predetermined pathways.

27. The gateway network system of claim 13 further comprising:
means in said gateway systems for allowing said gateway systems to actively coordinate with other gateway systems to determine, organize, and publish, alternate network pathways.

28. The gateway network system of claim 13 wherein each of said gateway systems further comprises:
means for actively overseeing and publishing physical and logical network topology.

29. The gateway network system of claim 13 wherein each of said gateway systems further comprises:
means for actively determining and publishing connection quality of its own upstream and downstream predetermined pathways for the purpose of delivering media.

30. The gateway network system of claim 13 wherein each of said gateway systems further comprises:
means for actively determining and publishing the connection quality of its upstream and downstream alternate pathways for the purpose of delivering media.

31. The gateway network system of claim 13 wherein any of said gateway systems further comprises:
means for actively selecting and publishing to other gateway systems, a best network pathway from any of predetermined and alternate pathways for the purpose of media delivery.

32. The gateway network system of claim 13 wherein any of said gateway systems further comprises:
means for actively selecting and publishing to other gateway systems, a best network pathway from any of predetermined and alternate pathways for the purpose of media type.

33. The gateway network system of claim 13 wherein at least one of said plurality of gateway systems further comprises:
means for performing at least one of the following:
network load balancing and Quality of Service (QoS).

34. The gateway network system of claim 13 wherein information necessary to actively establish alternative network pathways is determined for each network segment by the closest gateway system.

35. The gateway network system of claim 13 wherein information necessary to actively establish alternate network pathways is sent to all directly interconnected gateway systems.

36. The gateway network system of claim 13 wherein any gateway system with sufficient relevant resources can actively establish, publish, and co-ordinate itself as a gateway server.

37. The gateway network system of claim 13 wherein any of said gateway systems further comprises:
means for actively establishing, publishing, and coordinating itself as at least one of the following:
a temporary media server to other gateway systems;
a permanent media server to other gateway systems; and
a media server to end-user satellite station.

38. The gateway network system of claim 13 wherein any of said gateway systems further comprises:
means for actively selecting and publishing media content and parameters of media contained in other gateway systems to end-user devices for the purpose of delivering media from any server using the fastest pathway, chosen from any combination of predetermined and alternate pathways.

39. The gateway network system of claim 13 wherein any of said gateway systems further comprises:
means for actively selecting and publishing media content and parameters of media contained in other gateway systems to end-user devices for the purpose of delivering media from any server using the shortest pathway, chosen from any combination of predetermined and alternate pathways.

40. The gateway network system of claim 13 wherein any of said gateway systems further comprises:
means for actively selecting and publishing media content and parameters of media contained in other gateway systems to end-user devices for the purpose of delivering media from any server using Quality of Service (QoS) parameters, chosen from any combination of predetermined and alternate pathways.

41. The gateway network system of claim 13 wherein said media is stored in a location within said plurality of gateway systems that is closest to where said media is used.

42. The gateway network system of claim 13 wherein said media is delivered to a location within said plurality of gateway systems that is closest to where said media is used.

43. The gateway network system of claim 13 wherein at least one of said plurality of gateway systems is capable of performing media load balancing.

44. The gateway network system of claim 13 wherein information necessary to actively establish attributes selected from the group consisting of:
media delivery speed, media fragmentation, media fragment locations, network speed, shortest distance and network QoS, is sent to all directly interconnected gateway systems.

45. The gateway network system of claim 13 wherein directly interconnected gateway systems actively compare common network pathways to determine best pathway agreement for parameters from a group consisting of:
media delivery speed, media fragmentation, media fragment locations, network speed, shortest distance and network QoS.

46. The gateway network system of claim 13 wherein the information necessary to actively establish parameters from a group consisting of:
media delivery speed, media fragmentation, media fragment locations, network speed, shortest distance and network QoS, is propagated to all gateway systems within a network community.

47. The gateway network system of claim 13 wherein the information necessary to actively establish parameters from a group consisting of:
media delivery speed, media fragmentation, media fragment locations, network speed, shortest distance and network QoS, is propagated to all gateway systems within the network.

48. A method of storing and delivering media, said method comprising:
storing media, transmitted from at least one central media server, in the memory of a gateway system located remote from said central media servers, said central media servers accessible to said gateway system via an electronic network;
using said gateway system to interface a plurality of user devices to said electronic network; and
downloading a particular one of said stored media to at least one user interfaced thereto, said particular media being selected by said media server.

49. The method of claim 48, further comprising storing ones of said media as a result of downloading said media to one of said interfaced users as directed by said media server.

50. The method of claim 49, further comprising sending reports to said media server pertaining to downloaded ones of said media.

51. The method of claim 49, further comprising receiving reports from said media server pertaining to downloaded ones of said media.

52. The method of claim 49 wherein said gateway system comprises a plurality of gateway servers and wherein each gateway server determines, maintains, publishes, and propagates network connection and topology changes, said method comprising the use of at least one function from the list of:
a time-stamped local connection list, a time-stamped community connection list, a time-stamped regional connection list, a time-stamped network connection list, validating time-stamped lists to ensure lists contain latest information, and network authorization/encryption.

53. The method of claim 48 wherein said gateway system comprises a plurality of gateway servers and wherein each gateway server determines, maintains, publishes, and propagates media changes, said method comprising the use of at least one function from the list of:
a time-stamped local media list, a time-stamped community media list, a time-stamped regional medial list; a time-stamped network media list, validating time-stamped lists to ensure lists contain latest information, media authorization/encryption, and media demographics.

54. The method of claim 48 wherein said gateway system comprises a plurality of gateway servers and wherein each gateway server determines its capacity to become a gateway server based on available resources.

55. The method of claim 48 wherein said gateway system comprises a plurality of gateway servers and wherein each gateway server determines its capacity to become a media server based on available resources.

56. The method of claim 48 wherein said gateway system comprises a plurality of gateway servers and wherein each gateway server determines its capacity to store and maintain a ranked list of popular media based on available resources.

57. The method of claim 48 wherein said gateway system comprises a plurality of gateway servers and wherein each gateway server sends, receives, forwards, validates, authorizes, denies and deletes media requests.

58. The method of claim 48 wherein said gateway system comprises a plurality of gateway servers and wherein each gateway server actively sends, receives, forwards, validates, authorizes, denies and deletes media requests.

59. The method of claim 58 wherein each gateway server actively archives information pertaining to activities selected from the group consisting of:
sending, receival, forwarding, validating, authorization, denial and deletion of media requests, to a central server for security, media theft, and network and media abuse purposes.

60. The method of claim 48, wherein said gateway server comprises a plurality of gateway servers and wherein each gateway performs the function of auto-discovery, auto-insertion, auto-reorganization, and auto-sign-off of network and media information.

61. The method of claim 49 wherein said gateway system comprises a plurality of gateway servers and wherein each gateway server performs the function of optimal auto-discovery, optimal auto-insertion, and optimal auto-reorganization of network and media information.

62. The method of claim 48 wherein said gateway system comprises a plurality of gateway servers and wherein the same media is stored on various gateway servers.

63. The method of claim 48 wherein said gateway system comprises a plurality of gateway servers and wherein different media is stored on various gateway servers.

64. A method of delivering media from a web site to an end-user, said method comprising:
receiving requests at said website from an end-user for a desired media to be delivered to said end-user;
sending said desired media to said end-user over an Internet connection which involves at least one gateway system between said end-user and said request receiving web site;
storing at least some of said sent ones of said desired media at said gateway system; and
sending from said gateway system to a different end-user, media desired by said different end-user, upon a received request from said different end-user for desired media stored at said gateway system.

65. The method of claim 64 wherein said network is any wide-area network.

66. The method of claim 64 wherein said end-user requests said desired media using a user device different from the user device to which said desired media is to be downloaded.

67. The method of claim 64 further comprising controlling at least a portion of each sending from said website without regard to the location from which said media is sent.

68. The method of claim 67 wherein said controlled portion is billing control.

69. The method of claim 67 wherein said controlled portion is media verification.

70. The method of claim 67 wherein said controlled portion is media authorization.

71. The method of claim 67 wherein said controlled portion is encryption.

72. The method of claim 67 wherein said controlled portion is gateway system performance and load management.

73. The method of claim 67 wherein said controlled portion is network performance and load management.

74. The method of claim 67 wherein said controlled portion is QoS.

75. The method of claim 67 wherein said controlled portion is virus/spam detection.

76. A media distribution system comprising:
means for receiving requests at a website, from an end-user, for a desired media to be delivered to said end-user;
means for sending said desired media to said end-user over an Internet connection which involves at least one gateway system between said end-user and said request receiving web site; and
a gateway system operable for storing at least some portion of said sent ones of said desired media, said gateway system operable for sending media to a different end-user media desired by said different end-user, upon a received request from said different end-user for desired media stored at said gateway system.

77. The method of claim 76 wherein said network is any wide-area network.

78. The media distribution system of claim 76 wherein said end-user requests said desired media using a user device different from the user device to which said desired media is to be downloaded.

79. The media distribution system of claim 76 further comprising controlling at least a portion of each sending from said website without regard to the location from which said media is sent.

80. The media distribution system of claim 79 wherein said controlled portion is billing control.

81. The media distribution system of claim 80 wherein said controlled portion is authorization control.

82. The media distribution system of claim 79 wherein said controlled portion is encryption control.

83. The media distribution system of claim 79 wherein said controlled portion is QoS control.

84. A software program operable on a connecting device, connecting a sub-network of user devices to an electronic network, said software program comprising:
code for storing media transmitted from at least one central media server located remote from said connecting device; said media servers accessible to said connecting device via said electronic network;
code for interfacing said connecting device with said plurality of user devices in said electronic network; and
code for downloading media requested by said user devices interfaced with said connecting device.

85. The software program of claim 84 wherein the connecting device is a gateway system.

86. The software program of claim 84 further comprising code for tracking media stored on said gateway system.

87. The software program of claim 84 further comprising code for storing ones of said media as a result of downloading said media to one of said interfaced users as directed by said media server.

88. The software program of claim 84 further comprising code for sending reports to said media server pertaining to downloaded ones of said media.

89. The software program of claim 84 further comprising code for downloading said requested media to a user device different from said user device from which the request originated.

90. A system of reducing bandwidth costs for the transmission of media, said system comprising:
at least one memory for storing therein media transmitted from at least one central media server located remote from a gateway system, said media servers accessible to said gateway system via an electronic network;
at least one processor for interfacing a plurality of user devices to said electronic network;
means for tracking where said stored media is being stored within said gateway system;
means for determining which of said locations storing said particular media is the best source for downloading said media to a particular one of said user devices;
means for determining which route within said electronic network is best for delivering said particular media from said best location; and
said at least one processor further operable for downloading a particular one of said stored media to at least one user interfaced thereto, from said best location and along said best route, said particular media being selected by said media server.

91. A method of reducing bandwidth costs for the transmission of media said method comprising:
storing media, transmitted from at least one central media server, in the memory of a gateway system located remote from said media servers, said media servers accessible to said gateway system via an electronic network;
using said gateway system to interface a plurality of user devices to said electronic network;
determining the best location to a particular one of said plurality of user devices where a particular one of said media has been stored;
determining the best route of delivering said media from said best location; and
downloading from said gateway system said particular one of said stored media to said particular user device from said best location along said best route, said particular media being selected by said media server.

92. A system of caching media closest to its end user, said system comprising:
at least one memory for storing therein media transmitted from at least one central media server located remote from said gateway server, said media servers accessible to said gateway system via an electronic network;
at least one processor for interfacing a plurality of user devices to said electronic network;
said at least one processor further operable for determining the location within said gateway system closest to the user of said media; and
said processor further operable for downloading a particular one of said stored media to said location within said gateway system closest to the user of said particular media, said particular media being selected by said media server.

93. A method of caching media closest to its end user, said method comprising:
storing media, transmitted from at least one central media server, in the memory of a gateway system located remote from said media servers, said media servers accessible to said gateway system via an electronic network;
using said gateway system to interface a plurality of user devices to said electronic network;
determining the location within said gateway system closest to the user of said media;
downloading from said gateway system a particular one of said stored media to a location in said gateway system closest to said end user of said particular media, said particular media being selected by said media server.
